(19) United States
(12) Patent Application Publication
(10) Pub. No.: US 2026/0280963 A1
(43) Pub. Date: Sep. 17, 2026

(54) SYSTEMS AND METHODS FOR RUGGEDIZED OPTICAL-TO-ELECTRICAL AND PROTOCOL CONVERSION

(71) Applicant: Verizon Patent and Licensing Inc., Basking Ridge, NJ (US)

(72) Inventor: Michael S. Brusca, Woodbury, NY (US)

(21) Appl. No.: 19/079,724

(22) Filed: Mar. 14, 2025

(51) Int. Cl. H04L 41/042; H04B 10/25; H04L 41/0806; H04L 69/085

(52) U.S. Cl. CPC H04L 41/042; H04B 10/25; H04L 41/0806; H04L 69/085

(57) ABSTRACT

A method, a network device, and a non-transitory computer-readable storage medium are described in relation to an optical-to-electrical and protocol conversion service. The service includes receiving information for remote network equipment. The information is received via an optical fiber connection and in a first management protocol format. The service also includes converting the information for the remote network equipment into a second protocol format, forwarding the converted information to the remote network equipment via an Ethernet connection. The service further includes receiving, via the Ethernet connection, a response from the remote network equipment in the second protocol format, converting the response into the first protocol format, and forwarding the response via the optical fiber connection.

### BACKGROUND

Edge networks allow high network computing workloads to be transferred onto servers at the edge of the network. Depending on the location of the edge servers relative to the point of attachment (e.g., a wireless station for an end device), edge networks can provide various services and service levels to end devices. However, the distributed nature of the edge network creates communication, configuration, and monitoring challenges.

### BRIEF DESCRIPTION OF THE DRAWINGS

FIG. 1 is a diagram illustrating an exemplary environment in which systems and methods described herein may be implemented;

FIG. 2A is a schematic illustration of a pole-mounted configuration for the optical-to-electrical and protocol conversion service, according to an implementation;

FIG. 2B is a schematic illustration of a shroud enclosed configuration for an optical-to-electrical and protocol conversion service, according to another implementation;

FIG. 2C is a schematic illustrating an inside-pole configuration for an optical-to-electrical and protocol conversion service, according to yet another implementation;

FIG. 3 is a messaging diagram illustrating communications among components of the environment of FIG. 1 according to an implementation;

FIG. 4 is another messaging diagram illustrating communications among components of the environment of FIG. 1 according to another implementation;

FIG. 5 is a diagram illustrating exemplary components of a device that may correspond to one or more of the devices illustrated and described herein;

FIG. 6 is a flow diagram illustrating an exemplary process of an embodiment of the optical-to-electrical and protocol conversion service according to an implementation; and

FIG. 7 is a flow diagram illustrating an exemplary process of an embodiment of the optical-to-electrical and protocol conversion service according to another implementation.

### DETAILED DESCRIPTION

The following detailed description refers to the accompanying drawings. The same reference numbers in different drawings may identify the same or similar elements. Also, the following detailed description does not limit the invention.

Software-defined networking (SDN) and/or network function virtualization (NFV) may allow network functions (NFs) of a wireless telecommunications network to execute from reconfigurable resources of function-agnostic hardware. The NFs may be deployed in disaggregated network architectures along with optimized provisioning management. Some NFs may be deployed in devices at network edge or "far" edge locations (e.g., closest in proximity to the end users). For a virtual network function (VNF) deployed at the network edge or the far edge there are a number of challenges associated with deployments at scale. For example, these VNFs periodically require software or firmware updates to continue operating properly, as well as require new features to address bugs (e.g., software bugs) or security improvements.

Far edge server devices (i.e., hardware) that support virtual Distributed Units (vDU) of a wireless access station (e.g., a Next Generation Node B or gNB) may be installed at the base of a cell tower or in buildings. For future installations, mounting of these far edge server devices on utility poles is being contemplated, where ruggedized vDU equipment can be configured and monitored in support of both 5G and 4G (LTE) Radio Access Network (RAN) services at the same location that mounts antennas and radio units. Regardless of the installed location, regular shutdown and reboot of the server devices are required for firmware updates and other maintenance. However, rebooting the server devices presents challenges for distant pole-mounted environments (and other distributed environments that entail difficult access). For example, Ethernet communications over copper wire used to interface the server for rebooting and re-powering are limited to about 100 meters, which prohibits use of remote restart instructions from a centralized location (e.g., from network equipment that support multiple vDUs). Conversely, fiber optic cable connections to the server devices cannot carry signals to reboot after the server device is shut down. Thus, during the rebooting cycle, the server can be remotely powered down with current fiber optic technology, but there is no way to initiate a restart without physically dispatching a technician to the site if the vDU is powered down with only optical connections that lost power along with other components that comprise the vDU device. Furthermore, frequent dispatching of technicians to individual pole-mounted radio and vDU sites to maintain 4G and 5G service is time-consuming, expensive, and impractical. The maintenance of devices that are mounted at the top of utility poles for example entail the more costly use of bucket trucks and other types of lift vehicles that need to scale to the top of the pole, while or other types of ground level dispatch are costly but to a lesser extent.

Network equipment (e.g., function-agnostic hardware) that operates the vDUs may include proprietary interfaces. With multiple vendors providing network equipment for different locations, it is possible that different proprietary interfaces may be used for different vDUs controlled from the same centralized location. Thus, to enable network providers to move away from the continued use of proprietary baseband equipment and tightly integrated software typically from the same radio supplier, generic messages from a centralized management system may need to be converted to an appropriate proprietary interface before reaching a server's Base Management Controller (BMC).

Systems and methods described herein provide an optical-to-electrical and protocol conversion service. The optical-to-electrical and protocol conversion service implements a Ruggedized Optical-to-Electrical and Protocol Convertor (ROEPC) device, also referred to herein as a converter device or a network device. The ROEPC device is connected via copper based Ethernet connection to the vDU device port such as an RJ45 or similar electrical port. In addition, the ROEPC device is connected via a fiber optic cable to a centralized hub location such as C-RAN. Further, the ROEPC has an interface such as an RJ45 or wireless (e.g., WI-FI, Bluetooth, etc.) for a local connection to a laptop computer or mobile phone type of end device 150. The ROEPC device converts protocols from a management subsystem into a format that can be received by proprietary interfaces of server devices at remote locations, such as sites with ruggedized vDU servers mounted on utility poles. The systems and methods also perform optical-to-electrical conversion of signals to enable firmware and software updates requiring full restarts remotely.

According to an implementation, at least some of the optical-to-electrical and protocol conversion service is performed by the ROEPC device. The service may include receiving information for configuring and monitoring remote network equipment, such as a server device for a vDU device. The information may be received via an optical fiber connection and in a first management protocol format and may include a command to power down the remote network equipment. The service also may include converting the information for configuring and monitoring the remote network equipment into a second protocol format, forwarding the converted information to the remote network equipment via an Ethernet connection, and sending a reboot message via the Ethernet connection after the remote network equipment powers down. In this way, remote maintenance of vDU devices or the like can be managed. The mounting of the ROEPC device may be at or adjacent to the base of the pole (e.g., in a shroud) for easier ground level or remote access for purposes including rebooting or re-powering after firmware or software updates that depend on an electrical connection to the vDU device.

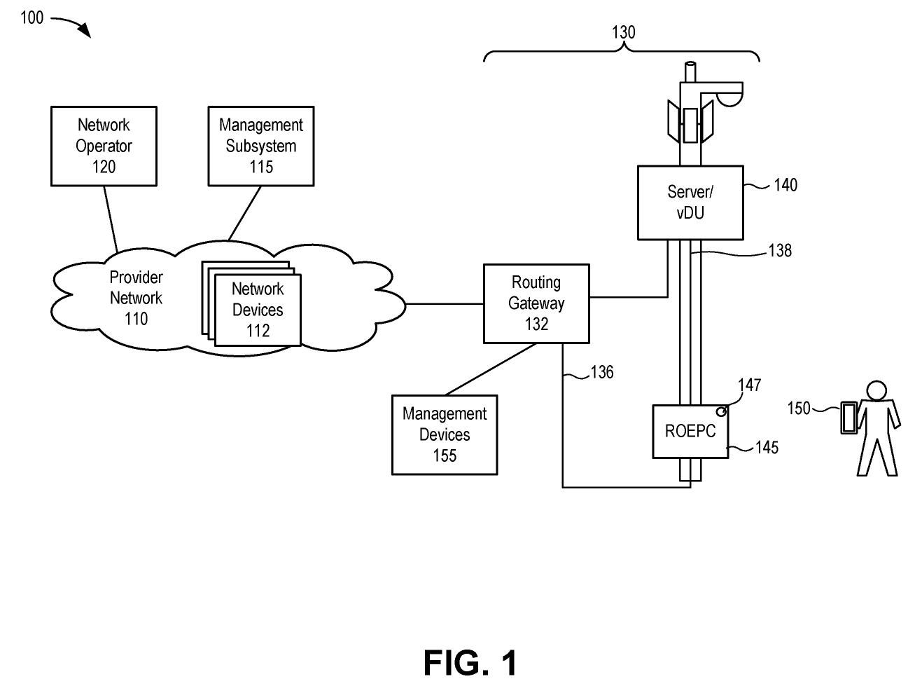

FIG. 1 is a diagram illustrating an exemplary environment 100 in which an embodiment of the optical-to-electrical and protocol conversion service may be implemented. As illustrated, environment 100 includes a network 110 that connects a management subsystem 115 and a network operator device 120 to devices at a network edge 130. Devices at edge 130 may include a routing gateway 132, a ruggedized vDU device 140, and a ROEPC device 145. Environment 100 further includes end devices 150 (also referred to individually or generally as end device 150 such as a laptop computer and a smart phone) and Management devices of others that access the network to manage it such as operations teams 155.

The number, type, and arrangement of networks/devices illustrated in environment 100 are exemplary. For example, according to other embodiments, environment 100 may include fewer networks, additional networks, and/or different networks. For example, according to other embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein. Also, while a single ruggedized vDU device 140 and ROEPC device 145 are shown in FIG. 1, in practice many of these devices may be located at different "far-edge" locations of environment 100.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, far edge, and/or another type of computing architecture, and may be incorporated into distinct types of network architectures (e.g., Software Defined Networking (SDN), virtual, logical, etc.), as well as used to support other types of network elements (e.g., network slices, QoS flows, PDU sessions, PDN sessions, channels, network paths, tunnels, etc.).

Environment 100 includes communication links between the networks and between the network devices. Environment 100 may be implemented to include wired, optical, and/or wireless communication links. For example, a fiber/optical connection 136 is illustrated between routing gateway 132 and ROEPC 145, while a wired/Ethernet connection 138 is illustrated between ROEPC 145 and ruggedized vDU device 140. A communication link or connection may be direct or indirect. For example, an indirect communication link may involve an intermediary device and/or an intermediary network not illustrated in FIG. 1. A direct communication link may not involve an intermediary device and/or an intermediary network.

Environment 100 may include various planes of communication including, for example, a control plane, a user plane, a service plane, and a network management plane. Environment 100 may include other types of planes of communication. A message communicated in support of the optical-to-electrical and protocol conversion service may use at least one of these planes of communication. According to various implementations, the interface of the network device may be a service-based interface, a reference point-based interface, an Open Radio Access Network (O-RAN) interface, a 5G interface, another generation of interface (e.g., 5G Advanced, Sixth Generation , etc.), or some other type of network interface (e.g., proprietary, etc.).

Provider network 110 may include one or multiple networks of one or multiple types that are capable of receiving and transmitting data, voice and/or video signals that are supported by devices including those at the edge as part of the telecommunications services it provides to customers. For example, provider network 110 may include one or more public switched telephone networks (PSTNs) or other type of switched network. Provider network 110 may also include one or more wireless networks and may include a number of wireless stations for receiving wireless signals and forwarding the wireless signals toward the intended destination. Provider network 110 may further include one or more satellite networks, one or more packet switched networks, such as an Internet protocol (IP) based network, a software defined network (SDN), a local area network (LAN), a WI-FI network, a wide area network (WAN), a long term evolution (LTE) network, a fourth generation (4G) network, a 4G LTE Advanced network, a fifth generation (5G) network, a core network, an intranet, the Internet, or another type of network that is capable of transmitting data. Some or all of provider network 110 may include a private domain or virtual private cloud. In some aspects, portions of provider network 110 may provide packet-switched services and wireless Internet protocol (IP) connectivity to end devices 150 to provide, for example, data, voice, and/or multimedia services during communication sessions.

Provider network 110 may support communications protocols and message formats for packet-switched communications. For example, network 110 may support Transport Control Protocol (TCP), Internet Protocol (IP), and other network communication protocols. Any packet data format may be transmitted over network 110. In one implementation, messages may be sent over network 110 in the form of objects as used in object-oriented programming or artificial intelligence. In one example, network 110 includes a regional broadband network that supports IP message format.

Provider network 110 may further include compute resources, such as cloud compute resources or Multi-access Edge Computing (MEC) compute resources that can provide services for applications and other enhanced services. For example, a customer application may offload compute tasks to a cloud platform or MEC platform that can provide services that are not capable by a local processor in a client device, but can be provided within a timing constraint of the customer application.

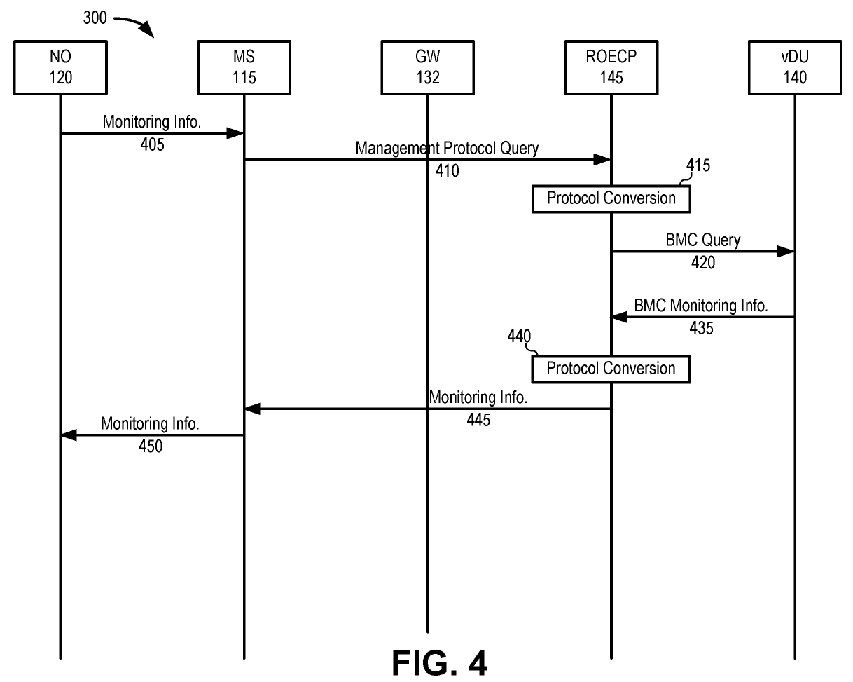

Components of provider network 110 may be implemented as dedicated hardware components, virtual network functions (VNFs), and/or containerized network functions (CNFs), implemented on top of a common shared physical infrastructure using SDN. For example, an SDN controller may implement one or more of the components of provider network 110 using an adapter implementing a VNF virtual machine, a CNF container, an event driven serverless architecture interface, and/or another type of SDN architecture. The common shared physical infrastructure may be implemented using one or more devices 400 described below with reference to FIG. 4 in a cloud computing or MEC platform associated with provider network 110.

Depending on the implementation, provider network 110 may include one or multiple types of network devices 112. For example, network devices 112 may include RAN devices, such as a gNB, an enhanced LTE (eLTE) evolved Node B (eNB), an eNB, a radio network controller (RNC), a RAN intelligent controller (RIC), a base station controller (BSC), a remote radio head (RRH), a baseband unit (BBU), a radio unit (RU), a remote radio unit (RRU), a centralized unit (CU), a distributed unit (DU), a small cell node (e.g., a picocell device, a femtocell device, a microcell device, a home eNB, a home gNB, etc.), a 5G ultra-wide band (UWB) node, a future generation wireless access device. In FIG. 1, network devices 112 may include a Centralized Unit (CU) or virtualized CU (vCU) for a disaggregated RAN that communicates with its associated routing gateway and ruggedized vDU device 140 to establish a wireless connection between end device 150 and network 110.

In other implementations, network devices 112 may include core network devices, such as those that comprise a user plane function (UPF), an access and mobility management function (AMF), a session management function (SMF), a mobility management entity (MME), a packet data network gateway (PGW), a serving gateway (SGW), and/or a home subscriber server (HSS) and/or Unified Data Management that stores and manages subscriber data. According to other implementations, network devices 112 may include additional, different, and/or fewer network devices than those described. For example, network device 112 may include a gateway, a router, a switch, a firewall, a bridge, a proxy server, a server, or some other type of device that processes and/or transfers data.

Management subsystem 115 may include a management device or data storage device. In one implementation, management subsystem 115 may be configured to receive configuration and monitoring information provided by network operator device 120, store the configuration and monitoring information, and make the configuration and monitoring information available to other network devices 112 in environment 100, such as ROEPC device 145, via provider network 110. In some implementations, the configuration and monitoring information is managed according to a management protocol selected by a provider network 110, such as Redfish®, Intelligent Platform Management Interface (IPMI), and/or Simple Network Management Protocol (SNMP). Thus, for management subsystem 115 to receive configuration and monitoring information provided by network operator device 120, management subsystem 115 is configured to support the network provider 110 selected protocol. In other implementations, other known management protocols may be used to manage configuration and monitoring information, provided procedures are available for converting between the management protocol of the management subsystem 115 and the data format used by routing gateway 132 and ROEPC device 145. The monitoring information requested and collected via the ROEPC 145 of the vDU device140 includes: remote discovery and asset reporting of components and their health and telemetry, polling of component and port utilization, polling of sensor data and failures, power and environmental status, trouble reporting, settings changes including BIOS and thermal threshold changes, and recording of logs.

Network operator device 120 may include one or more computing devices, workstations, and/or network devices that keep management information up-to-date by providing updated and new configuration and monitoring information to management subsystem 115. In one implementation, network operator device 120 may include an operations, administration, and maintenance (OAM) platform. The OAM platform may perform, for example, tasks for operation, administration, and/or maintenance (or management) of the NFs, including those of a ruggedized vDU device 140. At a centralized location, the network operator device 120 collects uniform data from management subsystem 115 and compiles and parses that data, for example, into human viewable dashboards that present standard metrics that may be equally compared amongst a variety of vDU devices 140 with proprietary BMCs and associated configuration commands and monitoring requests.

Routing gateway 132 may include a switching and routing device to establish a connection with another device over the packet-switched network 110 and to send and receive messages and other forms of data over a packet-switched network in the environment 100. For example, routing gateway 132 may be configured to support a fronthaul transport network service between a vCU (e.g., one of network devices 112) and ruggedized vDU device 140. Routing gateway 132 may establish a physical layer connection, as well as perform higher layer functions including routing, forwarding, and other management and control functions. While FIG. 1 shows only one routing gateway 132 forming a connection with the packet-switched network 110, in other implementation multiple devices (e.g., multiple routing gateways 132) may be included in environment 100 for establishing connections to provider network 110. Using known network communication protocols, routing gateway 132 may transmit and receive messages to/from other network devices connected to the packet-switched network of environment 100. For example, the routing gateway 132 may route configuration and monitoring information, such as that for a ruggedized vDU device 140, and forward the configuration and monitoring information.

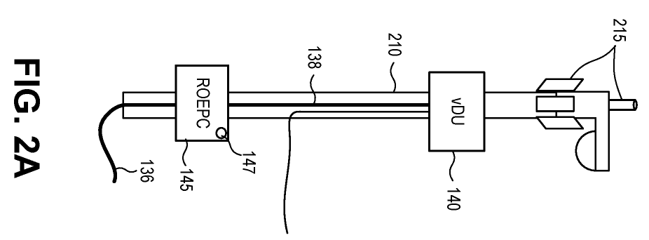

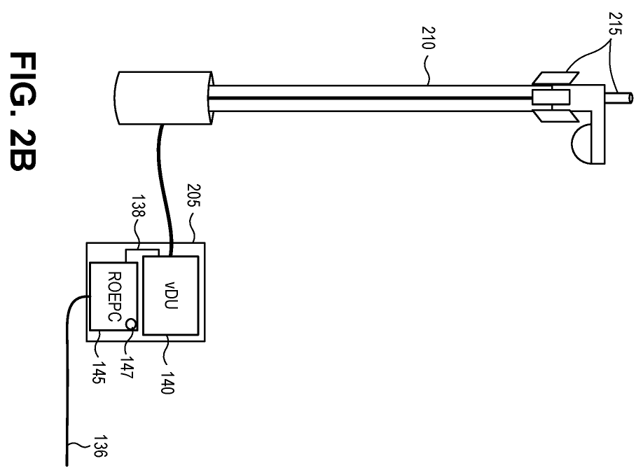

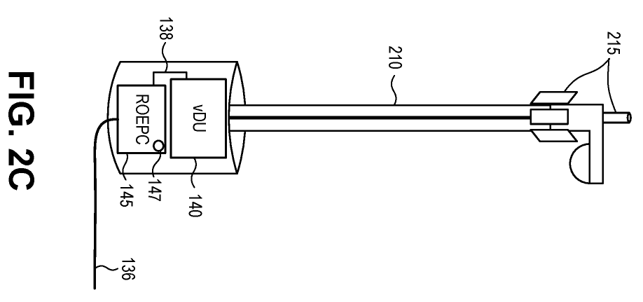

Ruggedized vDU device 140 may include function-agnostic hardware with reconfigurable resources configured to execute a vDU. Ruggedized vDU device 140 may also be referred to herein as remote network equipment, which are a part of the devices at the edge 130. Ruggedized vDU device 140 may, in some implementations, execute functions of a DU for a RAN, including functions associated with the Radio Link Control layer, the Medium Access Control (MAC) layer, and the physical layer (PHY). In one implementation, the DU may conform to standards for an O-DU. In some implementations, the DU may host a scheduler for managing use of physical resources for uplink and downlink signaling over a corresponding Radio Unit (RU). Under direction of a CU, the DU also may, for example, send paging signals to initiate communications with an end device 150 in idle mode. Ruggedized vDU device 140 may be manufactured by any of multiple vendors that use different proprietary management protocols. The management protocols of ruggedized vDU device 140 may differ from a network provider's management protocols used in provider network 110. According to an implementation described herein, ruggedized vDU device 140 may be installed inside a cabinet that is mounted near the top of a utility pole, within the utility pole, or in a shroud near the base of a utility pole, such as describe further below in connection with FIGS. 2A-2C.

ROEPC device 145 facilitates management and configuration of distant/remote network devices, such as ruggedized vDU device 140. In particular, ROEPC device 145 may be configured to convert management protocol messages (e.g., from management subsystem 115) to network protocol messages (e.g., for vDU device 140) and vice versa. ROEPC device 145 may include instructions and/or tools known for converting between management protocol and network protocol languages. In one implementation, ROEPC device 145 may use conversion techniques to convert Redfish® messages of a select schema version (from provider network 110) to proprietary server Base Management Control (BMC) messages (for ruggedized vDU device 140) and vice versa. In other implementations, a different management protocol (e.g., IPMI, SNMP, etc.) or different Redfish® version or schema or network device protocol (e.g., OpenBMC, vendor proprietary BMC format, etc.) may be used. ROEPC device 145 may also store instructions for converting the retrieved configuration and monitoring information from the one format to another format, such as converting server proprietary BMC or OpenBMC format messages to Redfish® format messages of various schemas.

ROEPC device 145 may be connected to routing gateway 132 via optical links (e.g., fiber/optical connection 136) and connected to ruggedized vDU device 140 via copper wire links (e.g., wired/Ethernet connection 138). According to another implementation, ROEPC device 145vmay include a physical port interface 147 to enable wired connections to an end device 150 for management/monitoring of vDU device 140. Other features of ROEPC device 145 are described further below in connection with, for example, FIGS. 2A-4. According to exemplary implementations described herein, a ROEPC device 145 may be installed at the base of a utility pole or inside a shroud that is near the base of a utility pole, near vDU device 140.

End device 150 may be used by technicians to configure and monitor vDU device 140 via wireless access or a physical port interface 147 of the ROEPC device 145. End device 150 may include any portable computing device. The end device 150 may have long-range (e.g., cellular or mobile wireless network) wireless communication functionality. For example, end device 150 may include a handheld wireless communication device (e.g., a mobile phone, a smart phone, a tablet device, etc.); a wearable computer device (e.g., a wristwatch computer device, etc.); a portable computer; a mobile device; a portable gaming system; global positioning system (GPS) device; a home appliance device; a home monitoring device; a fixed wireless access (FWA) device; and/or any other type of computer device with wireless communication capabilities. Other examples of end device 105 may include a machine-type communication (MTC) device, an Unmanned Aerial Vehicle (UAV), and an autonomous terrestrial vehicle. End device 150 may be implemented as a virtualized device in whole or in part. For purposes of description, end device 150 is not considered a network device.

Each of management devices 155 may include a computing device with wired/optical connections to routing gateway 132. For example, management device 155 may include a work station; a computer; or any other type of computer device with wired communication capabilities.

According to implementations described herein, routing gateway 132 is typically remote (e.g., about 3 to about 15 kilometers) from ruggedized vDU device 140 and, thus beyond range of wired Ethernet links between routing gateway 132 and ruggedized vDU device 140. According to systems and methods described herein, a ROEPC device 145 is co-located within a few millimeters to about 100 meters from each ruggedized vDU device 140 to perform optical-to-electrical signal conversion and management protocol conversion outside of the vDU device so that remote configuration/updates and monitoring of ruggedized vDU device 140 can be directed from management subsystem 115.

FIG. 2A is a schematic illustration of a pole-mounted configuration for the optical-to-electrical and protocol conversion service, according to an implementation where the ROEPC device 145 may be mounted on a utility pole 210 closer toward the bottom for ease of access and separated from its connected vDU device near the top of pole 210. FIG. 2B is a schematic illustration of another implementation in a shroud 205 (or another type of ground level enclosure) that may be installed alongside a utility pole 210. In the implementation of FIG. 2B, ruggedized vDU device 140 and ROEPC device 145 may be co-located within cabinet 205. In another implementation shown in FIG. 2C, a ruggedized vDU device 140 and ROEPC device 145 may be installed inside a pole 210. Various radios and antennas 215 for different frequencies and/or radio access technologies may also be mounted on pole 210. As examples, radios and antennas 215 may include those for C-Band, Narrowband including Advanced Wireless Service (AWS)/Personal Communications Service (PCS) band and 700 MHz and 850 MHz (cannister antenna), a millimeter wave (mmWave), and/or a Citizens Broadband Radio System (CBRS). ROEPC device 145 may receive management protocol messages via optical fiber link 136 and perform optical to electrical conversion independent of ruggedized vDU device 140.

ROEPC device 145 may also convert the management protocol messages to a network/proprietary protocol of the ruggedized vDU device 140 and forward the converted message to ruggedized vDU device 140 via, for example, an Ethernet link 138. In one implementation, ROEPC device 145 may be configured for proprietary protocols of a particular ruggedized vDU device 140. Thus, the conversion may be performed using known predefined mapping heuristics for translating a provider network 110 selected protocol format (e.g., Redfish®, etc.) used by management subsystem 115 to a proprietary BMC schema used by ruggedized vDU device 140. Accordingly, different ROEPC devices 145 may be configured differently for different ruggedized vDU devices 140. The protocol conversion would not be feasible at a centralized location such as a management subsystem 115, because messages from management subsystem 115 may be directed to multiple different ruggedized vDU devices 140 that have different proprietary interfaces. Further, the protocol conversion would not be feasible at a centralized location because monitoring data collected from management subsystem 115 cannot then be compiled and parsed into dashboards that represent key performance indicators (KPIs) for comparison of equal metrics, whereas embodiments described here fulfill this need.

ROEPC device 145 may include a small form factor and may be configured to withstand extreme weather (e.g., outdoor conditions), be powered by wired AC or DC connections (not illustrated for simplicity), and include long-range or short range optical connections for fiber link 136, such as a dedicated direct fiber or a fiber-to-the-premises (FTTP) line. For example, in one implementation, ROEPC device 145 may be configured to withstand high temperature exposure (e.g., IP66 or IP67 rating) and thermal shock, while operating at -40C to 55C plus solar loading, and within 5% to 85% relative humidity. In other implementations, ROEPC device 145 may be configured for passive cooling, passive cooling with fans that activate under extreme conditions, or active cooling such as with the use of fans and/or liquid cooling. The dimensioning of the ROEPC device 145 may be configured to allow it to be fit for mounting on or within existing utility poles or within ground mounted shrouds near pole 210, such as a street light pole, telephone pole, or traffic light pole as some examples.

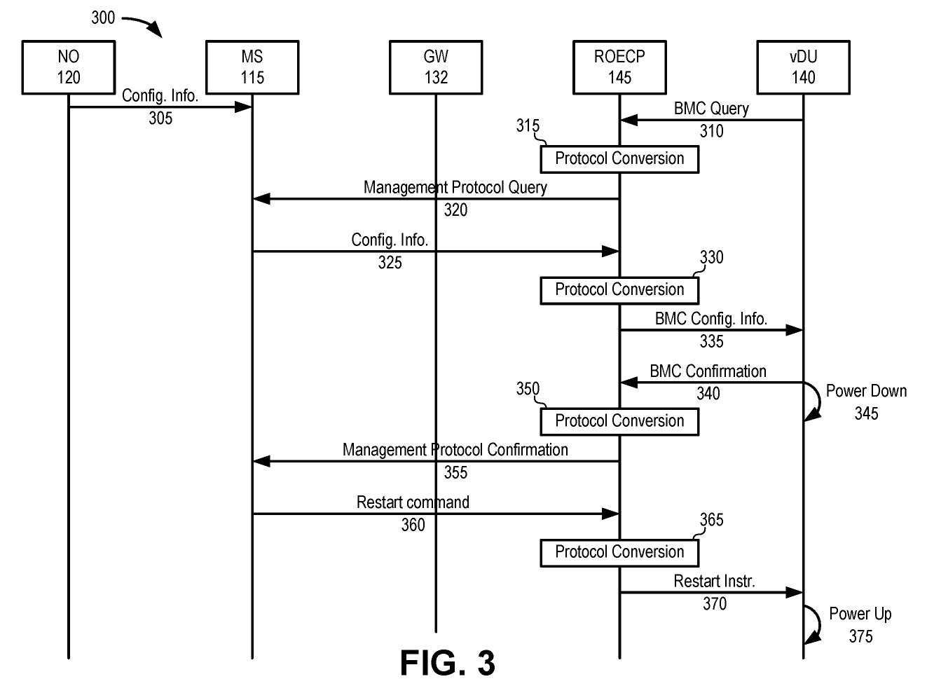

FIG. 3 is a signal flow diagram illustrating a process that may be performed using the optical-to-electrical and protocol conversion service in a portion 300 of network environment 100. More particularly, communications in FIG. 3 illustrate a remote configuration upgrade for a ruggedized vDU. Network portion 300 may include management subsystem 115, network operator device (NO) 120, routing gateway 132 ruggedized vDU device 140, and ROEPC device 145. FIG. 3 provides a simplified illustration of communications in network portion 300 and are not intended to reflect every signal, communication, or intermediate points for exchanges between functions/devices.

At step 305, NO 120 may provide, to management subsystem 115, updated or new configuration information for ruggedized vDU device 140. Management subsystem 115 may receive and store the configuration information.

At step 310, some time after step 305, ruggedized vDU device 140 may provide a BMC query. The BMC query may include a request, directed to management subsystem 115, in server-specific protocol format. For example, the request may include a check for updates. The request may be provided to ROEPC device 145 via an Ethernet link 138.

At step 315, ROEPC device 145 may convert the BMC query from a proprietary BMC protocol format used by the particular ruggedized vDU device 140 to a management protocol used by management subsystem 115. ROEPC device 145 may also perform electrical-to-optical conversion, changing from the received Ethernet interface (via link 138) to an optical interface for network 110 (link 136). At step 320, ROEPC device 145 may send the converted version of the query to management subsystem 115 (e.g., via routing gateway 132).

Management subsystem 115 may receive the converted query and identify that updated configuration for ruggedized vDU device 140 is available. At step 325, management subsystem 115 may send the updated configuration information toward ruggedized vDU device 140 (e.g., via routing gateway 132), using the provider's management protocol.

At step 330, ROEPC device 145 may receive the updated configuration information and convert the configuration information from the management protocol to the proprietary BMC protocol format used by the ruggedized vDU device 140. ROEPC device 145 may also perform an optical-to-electrical conversion, changing from the received optical interface for network 110 (link 136) to the Ethernet interface (via link 138) for ruggedized vDU device 140. At step 335, ROEPC device 145 may send the converted version of the configuration information to ruggedized vDU device 140.

Ruggedized vDU device 140 may receive and install the updated configuration information. As part of a firmware or software installation process, ruggedized vDU device 140 may send a confirmation to management system 115, at step 340, that the update is installed. Assuming a reboot is required to complete the configuration update, at step 345, ruggedized vDU device 140 may shut down.

ROEPC device 145 may receive the confirmation from ruggedized vDU device 140. At step 350, ROEPC device 145 may perform protocol conversion and electrical-to-optical conversion in a similar manner as described above in connection with step 315. ROEPC device 145 may then, at step 355, forward the converted BMC confirmation to management subsystem 115 (e.g., via routing gateway 132).

Management subsystem 115 may receive the converted BMC confirmation and, in response, issue a restart command for the ruggedized vDU device 140 that may have been without power for a prolonged period, until restart step 360. The restart command may be provided in the provider's management protocol. At step 365, ROEPC device 145 may receive the restart command and convert the restart command from the management protocol to the proprietary BMC protocol format used by the ruggedized vDU device 140. ROEPC device 145 may also perform an optical-to-electrical conversion, changing from the received optical interface for provider network 110 (link 136) to the Ethernet interface (via link 138) for ruggedized vDU device 140. At step 370, ROEPC device 145 may send the converted version of the restart command to ruggedized vDU device 140. In the powered down state, ruggedized vDU device 140 may receive the restart instructions via the Ethernet interface and at step 375, in response to the instructions, initiate a power up sequence. In previous systems, power up would not be feasible via an optical connection between vDU device 140 and ROEPC device 145 in cases when vDU device 140 has lost power. Further, the power up of vDU device 140 would only be feasible if power is resumed at the vDU device 140 to allow the startup.

FIG. 4 is a signal flow diagram illustrating another process that may be performed using the optical-to-electrical and protocol conversion service in network portion 300. More particularly, communications in FIG. 4 illustrate a remote monitoring process for a ruggedized vDU. FIG. 4 provides a simplified illustration of communications in network portion 300 and are not intended to reflect every signal, communication, or intermediate points for exchanges between functions/devices.

At step 405, NO 120 may provide, to management subsystem 115, a request for monitoring information from ruggedized vDU device 140. Management subsystem 115 may receive and store the monitoring information.

At step 410, some time after step 405, management subsystem 115 may provide a management protocol query. The management protocol query may include a request, directed to vDU device 140, in a network provider's preferred management protocol format. For example, the request may include a check for monitoring data. The request may be provided to ROEPC device 145 via optical connection 138, for example.

At step 415, ROEPC device 145 may convert the management protocol query to a proprietary BMC protocol format used by the particular ruggedized vDU device 140. ROEPC device 145 may also perform electrical-to-optical conversion, changing from the received optical interface (via link 138) to an Ethernet interface for vDU device 140 (link 136). At step 420, ROEPC device 145 may send the converted version of the monitoring data request to vDU device 140 as a BMC query.

In response to the BMC query, at step 435, vDU device 140 may send BMC monitoring information to ROEPC 145, using the proprietary BMC protocol format of vDU device 140. At step 440, ROEPC device 145 may convert the monitoring data from the proprietary BMC protocol format to the management protocol used by management subsystem 115. ROEPC device 145 may also perform electrical-to-optical conversion, changing from the received Ethernet interface (via link 138) to an optical interface for network 110 (link 136). At step 445, ROEPC device 145 may send the converted version of the monitoring data to management subsystem 115 (e.g., via routing gateway 132).

Management subsystem 115 may receive the converted monitoring information. At step 450 management subsystem 115 may send the monitoring information toward NO 120 using the provider's management protocol. The vDU device monitoring data can be compared with the monitoring data of other vDU device suppliers using uniform metrics presented at dashboards.

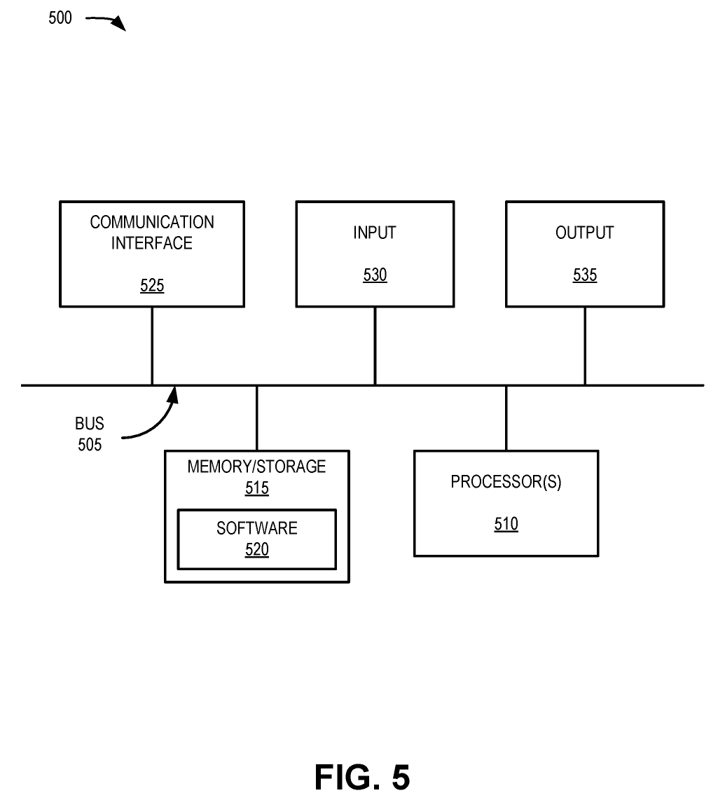

FIG. 5 is a diagram illustrating exemplary components of a device that may correspond to one or more of the devices illustrated and described herein. For example, device 500 may correspond to management subsystem 115, network operator device 120, ruggedized vDU device 140, ROEPC device 145, end device 150, management devices 155, and/or other types of devices, as described herein. As illustrated in FIG. 5, device 500 includes a bus 505, a processor 510, a memory/storage 515 that stores software 520, a communication interface 525, an input 530, and an output 535. According to other embodiments, device 500 may include fewer components, additional components, different components, and/or a different arrangement of components than those illustrated in FIG. 5 and described herein.

Bus 505 includes a path that permits communication among the components of device 500. For example, bus 505 may include a system bus, an address bus, a data bus, and/or a control bus. Bus 505 may also include bus drivers, bus arbiters, bus interfaces, clocks, and so forth.

Processor 510 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 510 may be implemented as hardware (e.g., a microprocessor, etc.), a combination of hardware and software (e.g., a SoC, an ASIC, etc.), may include one or multiple memories (e.g., cache, etc.), etc.

Processor 510 may control the overall operation, or a portion of operation(s) performed by device 500. Processor 510 may perform one or multiple operations based on an operating system and/or various applications or computer programs (e.g., software 520). Processor 510 may access instructions from memory/storage 515, from other components of device 500, and/or from a source external to device 500 (e.g., a network, another device, etc.). Processor 510 may perform an operation and/or a process based on various techniques and/or technologies including, for example, multithreading, parallel processing, pipelining, interleaving, machine learning, artificial intelligence, etc.

Memory/storage 515 includes one or multiple memories and/or one or multiple other types of storage mediums. For example, memory/storage 515 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory, a solid state memory, and/or some other type of memory. Memory/storage 515 may include a hard disk (e.g., a magnetic disk, an optical disk, a solid-state drive component, etc.), a Micro-Electromechanical System (MEMS)-based storage medium, and/or a nanotechnology-based storage medium.

Memory/storage 515 may be external to and/or removable from device 500, such as, for example, a Universal Serial Bus (USB) memory stick, a dongle, a hard disk, a solid state drive, mass storage, off-line storage, cloud storage, or some other type of storing medium. Memory/storage 515 may store data, software, and/or instructions related to the operation of device 500.

Software 520 includes an application or a program that provides a function and/or a process. As an example, with reference to ROEPC device 145, software 520 may include an application that, when executed by processor 510, provides a function and/or a process of the optical-to-electrical and protocol conversion service, as described herein. Software 520 may also include firmware, middleware, microcode, hardware description language (HDL), and/or other form of instruction. Software 520 may also be virtualized. Software 520 may further include an operating system.

Communication interface 525 permits device 500 to communicate with other devices, networks and systems. With ROEPC device 145 as an example device in environment 100, communication interfaces 525 may connect to vDU device 140 over copper Ethernet cable 138 and to routing gateway 132 over fiber optic link 136. Communication interface 525 includes one or multiple wireless interfaces, optical interfaces, and/or wired interfaces. For example, communication interface 525 may include one or multiple transmitters and receivers, or transceivers. Communication interface 525 may operate according to a protocol stack and a communication standard.

Input 530 permits an input into device 500. For example, input 530 may include a keyboard, a mouse, a display, a touchscreen, a touchless screen, a button, a switch, an input port, a joystick, speech recognition logic, and/or some other type of visual, auditory, tactile, affective, olfactory, etc., input component including artificial intelligence. Output 535 permits an output from device 500. For example, output 535 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, etc.). Device 500 may be implemented in the same manner. For example, device 500 may be instantiated, created, spun-up, uninstantiated, deleted, spun-down, or placed in some other operational state during its life cycle (e.g., refreshed, paused, suspended, rebooting, or another type of state or status), using well-known virtualization technologies.

Device 500 may perform a process and/or a function, as described herein, in response to processor 510 executing software 520 stored by memory/storage 515. By way of example, instructions may be read into memory/storage 515 from another memory/storage 515 (not shown) or read from another device (not shown) via communication interface 525. The instructions that are stored by memory/storage 515 may configure and cause processor 510 to perform a function or a process described herein. Alternatively, for example, according to other implementations, device 500 performs a function or a process described herein based on the execution of hardware (processor 510, etc.).

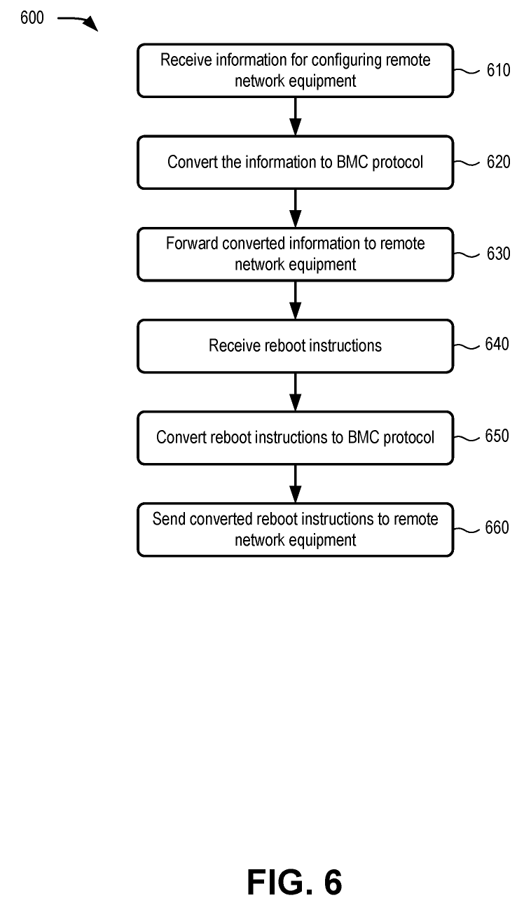

FIG. 6 is a flow diagram illustrating an exemplary process 600 of an embodiment of the optical-to-electrical and protocol conversion service. According to an embodiment, ROEPC device 145 may perform steps of process 600. According to an implementation, processor 510 executes software 520 to perform a step of process 600, as described herein. Alternatively, a step may be performed by execution of only hardware.

Process 600 may include receiving information for configuring remote network equipment (block 610) and converting the information to a BMC protocol (block 620). For example, ROEPC device 145 may receive configuration information from management subsystem 115 for ruggedized vDU device 140. The information may be provided via provider network 110 over an optical fiber connection (e.g., link 136) and in a first management protocol format. The configuration information may include, for example, a software or firmware update with a command to power down ruggedized vDU device 140 upon firmware or software installation. ROEPC device 145 may convert the information from a provider network 110 selected management protocol format to a proprietary BMC protocol format for ruggedized vDU device 140.

Process 600 may further include forwarding the converted information to the remote network equipment via an Ethernet connection (block 630). For example, ROEPC device 145 may forward the converted instructions to ruggedized vDU device 140 via Ethernet link 138. Ruggedized vDU device 140 may install the new configuration based on the information and follow instructions to power down (e.g., after loading firmware and/or software and providing an acknowledgement to management subsystem 115 via ROEPC device 145).

Process 600 may also include receiving reboot instructions (block 640), converting the reboot instructions to a BMC protocol (block 650), and sending the converted reboot instructions to the remote network equipment (block 660). For example, management subsystem 115 may provide instructions to power up after receiving the acknowledgement from ruggedized vDU device 140 (via ROEPC device 145). Management subsystem 115 may send reboot instructions to power up ruggedized vDU device 140. The reboot instructions may be provided via provider network 110 over an optical fiber connection (e.g., link 136) and in a first management protocol format. ROEPC device 145 may convert the reboot instructions to a proprietary BMC protocol format for use by ruggedized vDU device 140 and forward the converted reboot instructions to ruggedized vDU device 140 via an Ethernet connection (e.g., link 138).

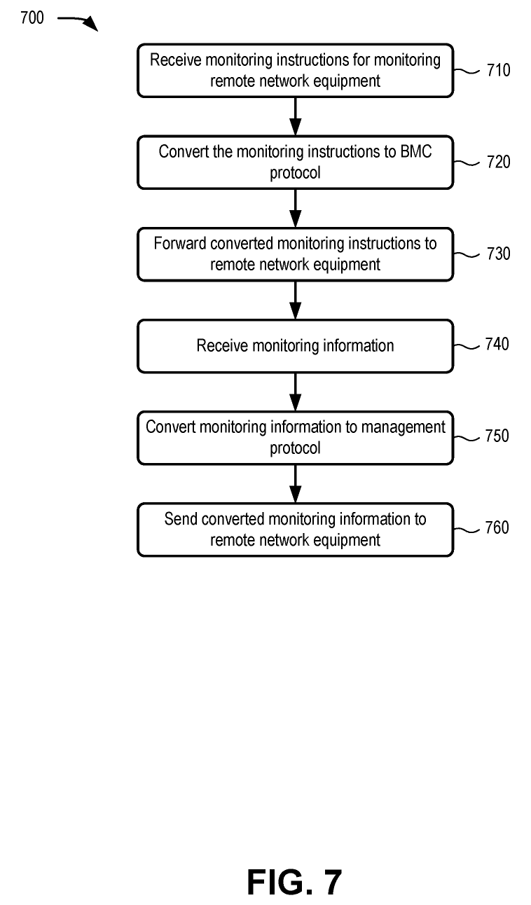

FIG. 7 is a flow diagram illustrating an exemplary process 700 of another embodiment of the optical-to-electrical and protocol conversion service. Process 700 may include receiving instructions for monitoring remote network equipment (block 710), converting the monitoring instructions to a BMC protocol (block 720), and forwarding the converted monitoring instructions to the remote network equipment via an Ethernet connection (block 730). For example, ROEPC device 145 may receive monitoring instructions from management subsystem 115 for obtaining monitoring data from ruggedized vDU device 140. The monitoring instructions may be provided via provider network 110 over an optical fiber connection (e.g., link 136) and in a first management protocol format. The monitoring instructions may include, for example, instructions to collect and provide data (e.g., power use data, performance data, QoS data, and/or other KPI data) from ruggedized vDU device 140. ROEPC device 145 may convert the monitoring instructions from a provider network 110 selected management protocol format to a proprietary BMC protocol format for ruggedized vDU device 140. ROEPC device 145 may forward the converted instructions to ruggedized vDU device 140 via Ethernet link 138.

Process 700 may also include receiving monitoring information (block 740), converting the monitoring information to a management protocol (block 750), and sending the converted monitoring information to the remote network equipment (block 760). For example, vDU device 140 may provide to ROEPC device 145 monitoring information that is responsive to the monitoring instructions. The monitoring information may be provided via an Ethernet link (e.g., link 138) and in the proprietary BMC protocol format. ROEPC device 145 may convert the management subsystem 115 to the management protocol used by management subsystem 115 and forward the converted monitoring information to management subsystem 115 (via gateway 132) using an optical fiber connection (e.g., link 136).

FIGS. 6 and 7 illustrates exemplary processes of the optical-to-electrical and protocol conversion service, according to other embodiments, the optical-to-electrical and protocol conversion service may perform additional operations, fewer operations, and/or different operations than those illustrated and described.

According to implementations described herein, a method, a network device, and a non-transitory computer-readable storage medium are described in relation to an optical-to-electrical and protocol conversion service. The service may include receiving information for remote network equipment. The information may be received via an optical fiber connection and in a first management protocol format. The service may also include converting the information for the remote network equipment into a second protocol format, forwarding the converted information to the remote network equipment via an Ethernet connection. The service may further include receiving, via the Ethernet connection, a response from the remote network equipment in the second protocol format, converting the response into the first protocol format, and forwarding the response via the optical fiber connection.

As set forth in this description and illustrated by the drawings, reference is made to "an exemplary embodiment," "exemplary embodiments," "an embodiment," "embodiments," etc., which may include a particular feature, structure, or characteristic in connection with an embodiment(s). However, the use of the phrase or term "an embodiment," "embodiments," etc., in various places in the description does not necessarily refer to all embodiments described, nor does it necessarily refer to the same embodiment, nor are separate or alternative embodiments necessarily mutually exclusive of other embodiment(s). The same applies to the term "implementation," "implementations," etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms "a," "an," and "the" are intended to be interpreted to include one or more items. Further, the phrase "based on" is intended to be interpreted as "based, at least in part, on," unless explicitly stated otherwise. The term "and/or" is intended to be interpreted to include any and all combinations of one or more of the associated items. The word "exemplary" is used herein to mean "serving as an example." Any embodiment or implementation described as "exemplary" is not necessarily to be construed as preferred or advantageous over other embodiments or implementations. The term "substantially" is used herein to represent a degree by which a quantitative representation may vary from a stated reference without resulting in a change in the basic function of the subject matter at issue.

In addition, while a series of blocks has been described regarding the process illustrated in FIGS. 6 and 7, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as "logic" or a "component." The logic or the component may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be used.

Use of ordinal terms such as "first," "second," "third," etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known "opt-in" or "opt-out" processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
receiving, by a network device, information for remote network equipment, wherein the information is received via an optical fiber connection and in a first management protocol format;
converting, by the network device, the information for the remote network equipment into a second protocol format;
forwarding, by the network device, the converted information to the remote network equipment via an Ethernet connection;
receiving, by the network device and via the Ethernet connection, a response from the remote network equipment in the second protocol format;
converting, by the network device, the response into the first protocol format; and
forwarding, by the network device, the response via the optical fiber connection.

2. The method of claim 1, wherein the information includes configuration information with a command to power down the remote network equipment, and wherein the method further comprises:
sending, by the network device and after the remote network equipment powers down, a reboot message via the Ethernet connection.

3. The method of claim 2, wherein sending the reboot message includes sending the reboot message to a Base Management Controller (BMC) of the remote network equipment using the second protocol format.

4. The method of claim 1, wherein the information includes monitoring instructions for the remote network equipment.

5. The method of claim 1, further comprising:
sending, by the network device and to a management server, a request for the information for the remote network equipment, wherein the request uses the first management protocol format.

6. The method of claim 1, wherein the information for the remote network equipment includes instructions for configuring or monitoring a virtual Distributed Unit (vDU) device.

7. The method of claim 1, wherein the information for the remote network equipment includes a firmware update.

8. The method of claim 1, wherein receiving the information for the remote network equipment includes receiving the information from a management subsystem over a packet-switched network.

9. The method of claim 8, further comprising:
provisioning, by a network operator device, the management subsystem with the information for configuring the remote network equipment.

10. The method of claim 1, wherein the remote network equipment and the network device are co-located on a same utility pole or within an enclosure near the utility pole.

11. A network device, comprising:
a first communication interface to send and receive messages via an optical fiber;
a second communication interface to send and receive messages via Ethernet;
a processor that is configured to:
receive information for remote network equipment, wherein the information is received via the first communication interface and in a first management protocol format;
convert the information for the remote network equipment into a second protocol format;
forward the converted information to the remote network equipment via the second communication interface;
receive, via the Ethernet connection, a response from the remote network equipment in the second protocol format;
convert the response into the first protocol format; and
forward the response via the optical fiber connection.

12. The network device of claim 11, wherein the information includes configuration information with a command to power down the remote network equipment, and wherein the processor is further configured to:
send, to the remote network equipment and after the remote network equipment powers down, a reboot message via the Ethernet connection.

13. The network device of claim 12, wherein, when sending the reboot message, the processor is further configured to:
receive a reboot instruction from a management server, wherein the reboot instruction uses the first management protocol format;
convert the reboot instruction into a second protocol format; and
forward the converted reboot instruction to the remote network equipment via the second communication interface.

14. The network device of claim 12, wherein, when sending the reboot message, the processor is further configured to:
send the reboot message to a Base Management Controller (BMC) of the remote network equipment.

15. The network device of claim 11, wherein the information for the remote network equipment includes a instructions to provide monitoring information to a management system.

16. The network device of claim 11, wherein the information for the remote network equipment includes instructions for configuring or monitoring a virtual Distributed Unit (vDU) device.

17. A non-transitory computer-readable storage medium storing instructions executable by a processor of a network device, wherein the instructions are for:
receiving, by the network device, information for remote network equipment, wherein the information is received via an optical fiber connection and in a first management protocol format;
converting, by the network device, the information for configuring the remote network equipment into a second protocol format;
forwarding, by the network device, the converted information to the remote network equipment via an Ethernet connection;
receiving, by the network device and via the Ethernet connection, a response from the remote network equipment in the second protocol format;
converting, by the network device, the response into the first protocol format; and
forwarding, by the network device, the response via the optical fiber connection.

18. The non-transitory computer-readable storage medium of claim 17, wherein the instructions are further for:
sending, by the network device and to a management server, a request for the information for the remote network equipment, wherein the request uses the first management protocol format.

19. The non-transitory computer-readable storage medium of claim 17, wherein the information for the remote network equipment includes:
information for configuring a virtual Distributed Unit (vDU) device, or
instructions for collecting monitoring data from the vDU device.

20. The non-transitory computer-readable storage medium of claim 17, wherein the information includes configuration information with a command to power down the remote network equipment, and wherein the instructions are further for:
receiving, from a management system, reboot instructions via the optical fiber connection and in the first management protocol format; and
sending, based on the reboot instructions, a reboot message via the Ethernet connection and in the second management protocol format.
